(19) United States
(12) Patent Application Publication
(10) Pub. No.: US 2005/0133106 A1
(43) Pub. Date: Jun. 23, 2005

(54) Hose with inner layer comprising ribs

(75) Inventors: Tevfik Severengiz, Gelnhausen (DE); Martin Ehret, Gelnhausen (DE)

Correspondence Address: BURNS DOANE SWECKER & MATHIS L L P, POST OFFICE BOX 1404, ALEXANDRIA, VA, 22313-1404, US

(73) Assignee: Veritas AG, Gelnhausen (DE)

(21) Appl. No.: 10/990,986

(22) Filed: Nov. 18, 2004

(30) Foreign Application Priority Data
Nov. 20, 2003 (DE) 103 54 211.6

(51) Int. Cl. F16L 11/00

(52) U.S. Cl. 138/121; 138/122; 138/137; 138/140

(57) ABSTRACT

The present invention describes a hose which at least at one end comprises ribs extending on the inside.

The present invention relates to a hose, particularly for conveying gases, such as hydrogen, and liquid media, such as fuels, coolants, oils, brake fluids, or the like.

Different types of hoses are known to be used in a fuel line system of an automotive vehicle or another vehicle, the hoses being producible from various materials. Such a hose may be used as the fuel line itself, or also as a connecting piece for connecting a fuel line, and may be configured to be flexible or rigid. In general, gasoline or diesel. fuel is conveyed through the lines to the engine.

These hoses often include a plurality of layers consisting of materials of different chemical compositions. For reasons of safety and also with respect to the standard environmental and safety criteria, one demand made on the tubes or hoses is that the vapors of standard fuels penetrating through walls and ends should be suppressed as much as possible. Moreover, the hoses should be resistant to high and low temperatures and should be flame-resistant or self-extinguishing. To meet these demands, it has e.g. turned out to be useful to provide a barrier layer in the hose to suppress the permeation of the fuels, and also further layers, e.g. a protective layer or a reinforcement layer, to give the hose the necessary strength and resistance. The connections, such as nozzles, must be substantially free from leakage and so-called wicking effects (penetration of the fuel through the layer which is e.g. in contact with the fuel).

Such hoses often have a structure in which a barrier layer is provided as the innermost layer, the barrier layer preferably consisting of a fluorine-containing thermoplastic material. Further functional layers, such as protective layers or reinforcement layers and adhesion promoting layers, are provided over said inner layer.

One problem arising in such hose systems is that these hoses do not always exhibit the necessary tightness when put onto other shaped parts, e.g. tank filler necks, depending on the surface quality thereof. Such tank filler necks, for instance, are shaped parts which have a parting plane. The defects are noticed in a disadvantageous way as recesses or elevations; leakage may then arise at said places. This is extremely disadvantageous above all in gas and liquid fuel systems.

In the prior art various approaches have therefore been made for overcoming this problem. The attempt is here made to improve the mechanical connection of hose and tank filler neck by mounting hose clamps, so that there is adequate tightness. The roughness height which can be sealed with this system is limited to 10 μm to 40 μm. Alternative approaches regard the insertion of further flexible and elastic inner layers before the thermoplastic as the inner layer so as to create, for instance, an improved adaptation to the tank filler neck surface. Furthermore, external sealing rings, sealing films or sealing adhesives may be used. The drawback of these approaches in the prior art is, however, that additional layers must be provided, which either makes the production of the hoses more expensive or increases the complexity of the installation of such hoses in fuel systems. Moreover, such layers promote the so-called “wicking effect”.

It is therefore the object of the present invention to provide a hose which overcomes the above-mentioned problems.

According to the invention this object is achieved by a hose which at least at one end, preferably at both ends, comprises ribs extending on the inside.

Surprisingly, such a configuration of the hose end, while maintaining the standard inner diameter of the hose, provides for improved tightness in hose connections on shaped parts of plastics or metal, e.g. tank filler necks. Due to the internally surrounding ribs, which partly reduce the inner diameter of the hose, the contact pressure of the hose increases on the tank filler neck. At the same time, at least the first thermoplastic layer runs—under contact pressure with the help of the subsequent elastomer layer and a clamp—in an optimum manner on the surface, resulting in improved tightness. A further advantage is that the withdrawal forces of the hoses are increased. Hence, slipping from the connection can also be prevented without a clamp.

Moreover, the configuration of the hose end according to the invention avoids the use of additional inner layers or additional materials, so that the drawbacks of the prior art entailed thereby do not arise. At the same time, the internally surrounding ribs can be shaped by means of standard shaping tools, e.g. directly during manufacture or during assembly for a desired use, starting from pre-shaped hoses without internally surrounding ribs.

According to the invention, the internally surrounding ribs may e.g. be formed by a corresponding configuration of an inner layer of the hose. Alternatively, it is also possible that in the case of multilayered hoses the further layers of the hose are also of such a structure, so that the internally surrounding ribs are present through an essential part of the cross section of the hose. The first option is called single-layered, the second multi-layered, e.g. up to six layers.

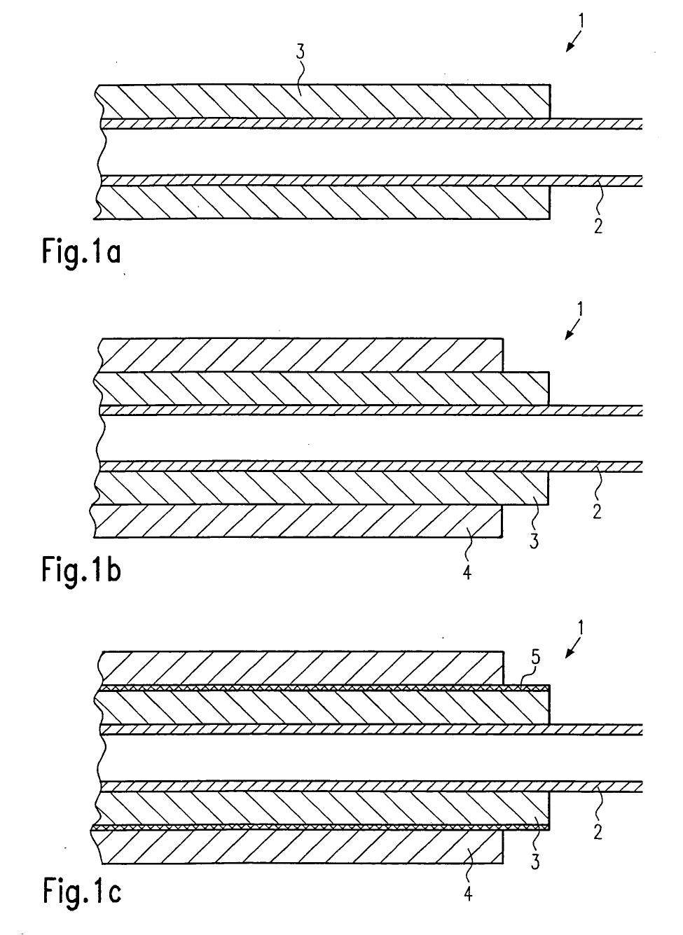

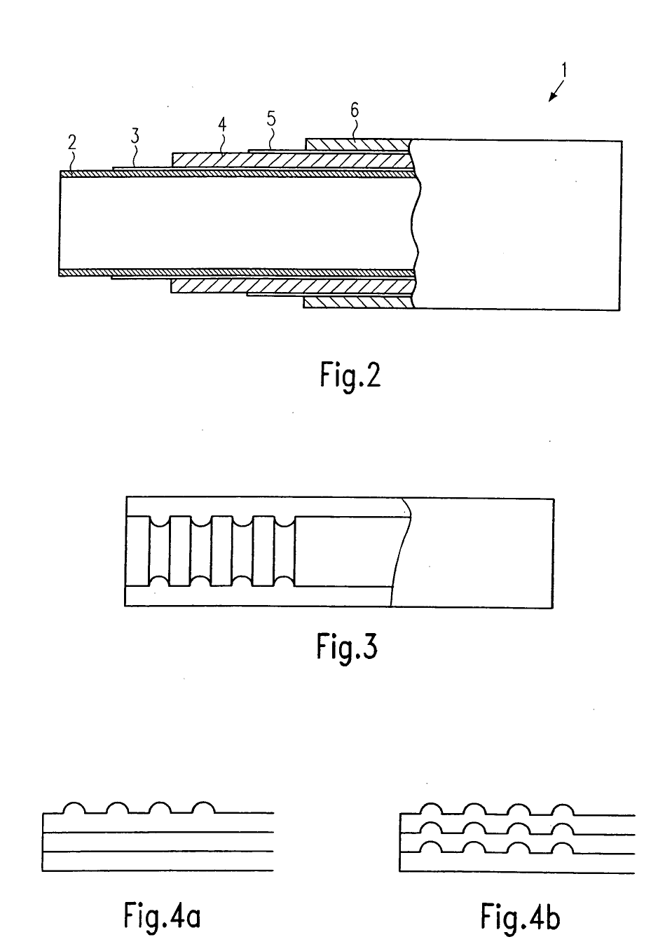

The present invention will now be described in more detail with reference to the accompanying drawings. FIG. 1 shows a possible layered structure of a hose of the invention. FIG. 2 shows a further possibility of a layered structure for a hose according to the invention. FIG. 3 is a schematic illustration showing four internally surrounding ribs. Each of FIGS. 4a and 4b schematically shows further developments with four surrounding ribs. The hose shape is once chosen such that the surrounding ribs are just formed in the inner layer (FIG. 4a) and once in all existing layers (FIG. 4b). The number of the ribs is proportional to the surface to be sealed and is at least 1. Number and shape are not limited in any way.

Hoses according to the invention preferably comprise, as the inner layer, a barrier layer of a fluorine-containing thermoplastic material, particularly preferably of PVDF, THV, CTFE, ECTFE, particularly THV, or polyamides. Classic elastomers such as NBR and FPM and thermoplastic elastomers with the required resistance to media are also suited. They may be single-layered or multilayered, they may be composed of the same layer or also of different layers and electrically conductive. Furthermore, the hoses according to the invention preferably comprise a further layer of a rubber material on the first layer, e.g. NBR, ECO, CSM, CM, ACM, AEM, CR, EPDM, or EVM, particularly preferably NBR or ECO. In addition, further functional layers may be provided, for instance reinforcement layers, preferably consisting of a fiber-like material, e.g. cotton fibers, cellulose fibers, rayon fibers, nylon fibers, polyester fibers, or aramide fibers, which are placed on the hose by winding, knitting or braiding. Further possible layers are adhesion promoting layers, conductive layers (for protection against electrostatic charge), thermoplastic protective layers and colored marking layers.

The respective thicknesses of the layers are chosen in response to the desired use, optionally in consideration of the costs for material and production.

FIG. 1 shows the layered structure of a fuel line 1 of the invention, according to a first embodiment. The fuel line 1 comprises a barrier layer 2, preferably made from a fluorine-containing thermoplastic material. Provided is further an elastomer layer 3 which encloses the barrier layer by adherence and interlocking. FIG. 1a shows the layered structure of a fuel line 1 of the invention, according to a further embodiment. The fuel line 1 comprises a barrier layer 2, preferably made from a fluorine-containing thermoplastic material. Provided is further an elastomer layer 3 which encloses the barrier layer by adherence and interlocking. A protective layer 4 is provided as the final layer.

FIG. 2 shows a further embodiment of the layered structure of a hose according to the invention. In this instance, a reinforcement layer 5 of a fiber-like material is further provided on the protective layer 4. A protective layer 6 is again provided as the final layer.

The internally surrounding ribs which are essential for the invention are schematically shown in FIG. 3. These ribs may have any desired shape, which is e.g. defined by the possibilities offered by the production plant. It is however preferred when the ribs according to the invention have a round or semicircular cross-section. Furthermore, it is preferred when the ribs are just provided at the end of the hose because this embodiment is the least cost-intensive one.

The ribs have preferably a height accounting for 0.5% to 15% of the inner diameter. Preferred is a range of 1% to 8%, particularly 2.5%. Hence, at an inner diameter of 40 mm, this yields a particularly preferred rib height of 1 mm.

It is preferred according to the invention when 1 to 25 internally surrounding ribs are provided at the hose end. Number, height and shape of the ribs are determined by the connection surface to be sealed. It is here particularly preferred when all ribs have the same height and the same width and are each equally spaced apart from one another.

The distance of the first internally surrounding rib should not have the same distance from the hose end as from the subsequent internally surrounding rib. It is particularly preferred that the width of each rib ranges from 1 mm to 14 mm, particularly preferably from 2 mm to 9 mm. If existing, the distance between each rib is 1 mm to 5 mm, and the distance from the first rib to the hose end is between 2 mm and 10 mm, preferably 6 mm.

The ribs according to the invention can be produced by suitable shaping methods, e.g. using preheated metallic shaping mandrels and sleeves which are placed around the hose end. In a multi-stage coextrusion method, such a shaping process may also take place in an intermediate step, prior to the application of the final protective layer.

1. A hose for conveying liquid and gaseous media, particularly fuels, wherein the hose comprises internally surrounding ribs on at least one end.

2. The hose according to claim 1, wherein the hose comprises at least one internally surrounding rib on at lease on end.

3. The hose according to claim 1, wherein the ribs are conductive.

4. The hose according to claim 1, wherein the ribs are not conductive.

5. The hose according to claim 1, wherein the ribs have a height of 0.5-15% of the inner diameter of the hose.

6. The hose according to claim 1, wherein the ribs have at lease one layer, preferably one to six layers.

7. The hose according to claim 1, wherein the ribs have the same width.

8. The hose according to claim 1, wherein the ribs have different widths.

9. The hose according to claim 1, wherein the ribs are spaced apart from one another at the same distance, the distance from the hose end to the first rib being different therefrom.

10. The hose according to claim 4, wherein the ribs are not spaced apart from one another at the same distance, the distance from the hose end to the first rib being different therefrom.

11. The hose according to claim 1, wherein the hose comprises an interior barrier layer and an elastomer layer provided thereabove.

12. The hose according to claim 1, wherein the hose comprises an interior barrier layer, an elastomer layer provided thereabove, and a protective layer provided thereabove.

13. The hose according to claim 1, wherein the hose comprises an interior barrier layer, an elastomer layer provided thereabove, and a reinforcement layer provided thereabove.

14. The hose according to claim 1, wherein the hose comprises an interior barrier layer, an elastomer layer provided thereabove, a reinforcement layer provided thereabove, and a protective layer.

15. The hose according to claim 11, wherein the barrier layer comprises a fluorine-containing thermoplastic material, preferably THV.

16. The hose according to claim 1, wherein the layer facing the medium is an elastomer.

17. The hose according to claim 1, wherein the layer facing the medium is a thermoplastic elastomer.

18. The hose according to claim 1, wherein the ribs
a) are just formed by the inner layer; or
b) substantially extend over all layers of the hose.

19. Use of a hose according to claim 1, for conveying gaseous and liquid fuels.

20. Use of a hose according to claim 1, for conveying gases, such as hydrogen, and liquid media, such as coolants, engine oils, brake fluids, hydraulic oils and hot air contaminated with media, etc.
